(19) United States
(12) Patent Application Publication
(10) Pub. No.: US 2010/0201240 A1
(43) Pub. Date: Aug. 12, 2010

(54) ELECTRON ACCELERATOR TO GENERATE A PHOTON BEAM WITH AN ENERGY OF MORE THAN 0.5 MEV

(76) Inventors: Tobias Heinke, Rudolstadt (DE); Sven Mueller, Urbich (DE); Stefan Setzer, Fuerth (DE); Markus Wenderoth, Rudolstadt (DE)

Correspondence Address: SCHIFF HARDIN, LLP;PATENT DEPARTMENT, 233 S. Wacker Drive-Suite 6600, CHICAGO, IL, 60606-6473, US

(21) Appl. No.: 12/699,462

(22) Filed: Feb. 3, 2010

(30) Foreign Application Priority Data
Feb. 3, 2009 (DE) 10 2009 007 218.7

(51) Int. Cl. H01J 7/26

(52) U.S. Cl. 313/35; 313/363.1

(57) ABSTRACT

An electron accelerator that generates a photon beam with an energy of more than 0.5 MeV by means of an electron beam charging a target has a vacuum chamber with an intake opening and an exit opening, and an electron source at the input side. The target is arranged outside the vacuum chamber in the region of the exit opening in a housing in which a window is present that is permeable to photons and that is arranged opposite the exit opening in the beam direction of the electron beam. The target is permeated by at least one cooling channel.

### BACKGROUND OF THE INVENTION

1. Field of the Invention

The present invention concerns an electron accelerator to generate a photon beam with an energy of more than 0.5 MeV, in particular for radiation therapy and for non-destructive materials testing.

2. Description of the Prior Art

In electron accelerators of the above type that are known from, for example, EP 0 872 872 A1 and EP 0 022 948, electrons emitted from an electron source are accelerated in a vacuum chamber, wherein they are directed onto a target upon leaving the vacuum chamber. Due to the high kinetic energy of the electrons, at least some electrons in the electron beam penetrate a layer of the target material. Photon radiation (Bremsstrahlung) with high energy in the MeV range arises due to the braking (deceleration) of the electrons in the target containing at least one element of higher atomic number (consisting of tungsten, for example). The arising photon beam exhibits the same direction as the electron beam. The electron beam and the photon beam thus have a common, linearly extending beam axis in an electron accelerator of the this type. This is different in x-ray tubes, which have a hot cathode and an anode. The electrons emitted from the hot cathode are accelerated in an electrical field present between cathode and anode strike the anode. The anode normally is not entirely composed of a material suitable for transduction of electrons into photons, but rather has a generally dish-shaped target made of such a material. The electrons of an x-ray tube achieve relatively low kinetic energies, such that the electron beam penetrates only into surface-proximal material layers of the target. The arising photon radiation thereby exhibits a lower energy in comparison to an electron accelerator of the aforementioned type, in a range from 1 keV to 250 keV. It does not penetrate the target but rather is emitted from the target surface charged by the electron beam. With regard to the beam path of electron beam and photon beam, a similar situation exists as for the reflection of light on a reflective surface. Therefore the term “reflection targets” issued for the targets of x-ray tubes and “transmission targets” issued for those of electron accelerators.

Medium beam powers in electron accelerators into the kilowatt range, beam diameters in the millimeter range and a lower degree of effectiveness in the transduction of the electron beam into the photon beam mean an extremely high local thermal loading of the target that can lead to its melting, and therefore to the failure of the entire apparatus. In order to prevent a melting of the target due to high thermal power concentrated on a focal spot, different cooling methods are used. In the electron accelerator known from EP 0 022 948 A1, the target is externally cooled with a cooling medium. In the electron accelerator described in EP 0 872 872 A1, in addition to this cooling the target is arranged in a region of a cooling channel and designed so that it is set into rotation by the flowing cooling medium. The rotation axis is thereby laterally offset relative to the beam axis of the incident electron beam. In this way the thermal energy is distributed on a focal ring of comparably large area instead of on a focal spot. A disadvantage of this type of design is that a design that ensures a long-term, functionally capable bearing is, depending on the type of the medium surrounding, cooling and/or lubricating the target, relatively expensive. In spite of the cooling measures taken, due to the high radiation powers in the known electron accelerators the danger also exists that the target is thermally overloaded.

### SUMMARY OF THE INVENTION

An object of the present invention is to toughen an electron accelerator of the aforementioned type so that a thermal overloading of the target is prevented.

This object is achieved according to the invention by an electron accelerator of the aforementioned type, having a vacuum chamber provided with an intake opening and an exit opening, and an electron source at the input side, with the target arranged outside the vacuum chamber in the region of the exit opening in a housing having a window permeable to photon beams and arranged opposite the exit opening in the beam direction of the electron beam, and wherein the target is permeated by at least one cooling channel. This design enables a rigid (thus non-rotating) target. The cooling channel or channels, through which a cooling medium naturally flows during operation, can be designed in manifold ways so that a sufficient heat dissipation preventing an overheating or even a melting of the target is ensured. The material region responsible for the transduction of electrons into photons is directly (and therefore extremely effectively) cooled via the embodiment of the target according to the invention.

In a preferred exemplary embodiment at least one volume region of the target permeated by the electron beam and/or the photon beam is formed from multiple material layers at a distance from one another in the beam direction, with at least one cooling channel bordering between two respective adjacent material layers. The material volume required for the transduction of the electron beam into photon radiation is thus sub-divided into multiple sub-layers of lesser thickness, so the surface available for cooling or, respectively, for contact with a cooling medium is enlarged. The principal function of the target—to convert the kinetic energy of quickly moving electrons into photons—thereby remains unaffected. Due to the lesser layer thickness of the individual material layers, their heat resistance is reduced. The heat incurred in the braking of the electron beam distributes nearly uniformly at the material layers. The heat dissipation can still vary through the radial (relative to the beam axis) extent of the material layers and the cooling channels located between them. In addition to the thickness of the material layers and their surface dimensioning, the volume flow rate of the coolant can also serve as a variable to maintain a defined temperature in the target or, respectively, the material layers. The sum of the thickness of the material layers of the target is determined by the kinetic energy of the electron beam, the target material used and the intended braking spectrum.

In an embodiment, the exit opening of the vacuum chamber is sealed by a vacuum-sealed window. The atmosphere surrounding the target can thus be determined independent of the vacuum of the vacuum chamber. The aforementioned window is composed of a material permeable to the electron beam. It can be omitted if—as in an exemplary embodiment—the target itself is used for a vacuum-tight seal of the exit opening of the vacuum chamber.

In another preferred exemplary embodiment, the target is arranged in a space that possesses a coolant input, a coolant output and a radiation exit window. This embodiment ensures a coolant supply and discharge that is technically simple to realize. It is thereby advantageous when the at least one cooling channel leads to two different sides of the target, wherein the sides are facing toward the coolant input or, respectively, the coolant output if the cooling channel thus extends in the flow direction of a coolant flowing through the space.

In a further embodiment, the target is arranged in a space that is connected with the vacuum chamber via its exit opening and that possesses a radiation exit window. In this case, the target is thus surrounded by vacuum. Such an embodiment is appropriate if a scattering of the photon radiation exiting from the target by molecules of the air should be prevented or at least reduced. The cooling of the target in the embodiment variant being discussed ensues in that the space accommodating the target is permeated in a vacuum-tight manner by a sub-segment of a coolant circuit, wherein the coolant channels of the target are connected to the coolant circuit.

### BRIEF DESCRIPTION OF THE DRAWINGS

FIG. 1 shows a first embodiment of an electron accelerator in accordance with the invention, in longitudinal section.

FIG. 2 shows the portion II from FIG. 1 in side view.

FIG. 3 shows a modified form of the electron accelerator of FIG. 1.

FIG. 4 shows a second embodiment of an electron accelerator in accordance with the invention in longitudinal section.

FIG. 5 shows the portion V in FIG. 3 in section, rotated by 90°.

FIG. 6 is a perspective view of a target.

### DESCRIPTION OF THE PREFERRED EMBODIMENTS

Each of the electron accelerators 1a, 1b, 1c shown in the figures has a vacuum chamber 2. This has, for example, a cylindrical housing 3 that is open on the facing sides by openings, namely an intake opening 4 and an exit opening 5. An electron source 6 is located in the region of the intake opening 4 (that is sealed gas-tight in a manner that is not shown in detail) and outside the vacuum chamber 2. The electrons emitted from said electron source 6 are accelerated in the vacuum chamber 2 and exit the vacuum chamber 2 via the exit opening 5 or from the window 9 sealing this in a vacuum-tight manner. The inner space of the vacuum chamber is designed in the form of cavities 8 arranged one after another in the beam direction 11 of the electron beam 7 generated by the accelerator 1a, 1b, 1c. These serve to maintain a standing electromagnetic wave serving to accelerate the electrons. Electron acceleration by means of a traveling electromagnetic wave or in another manner is also conceivable.

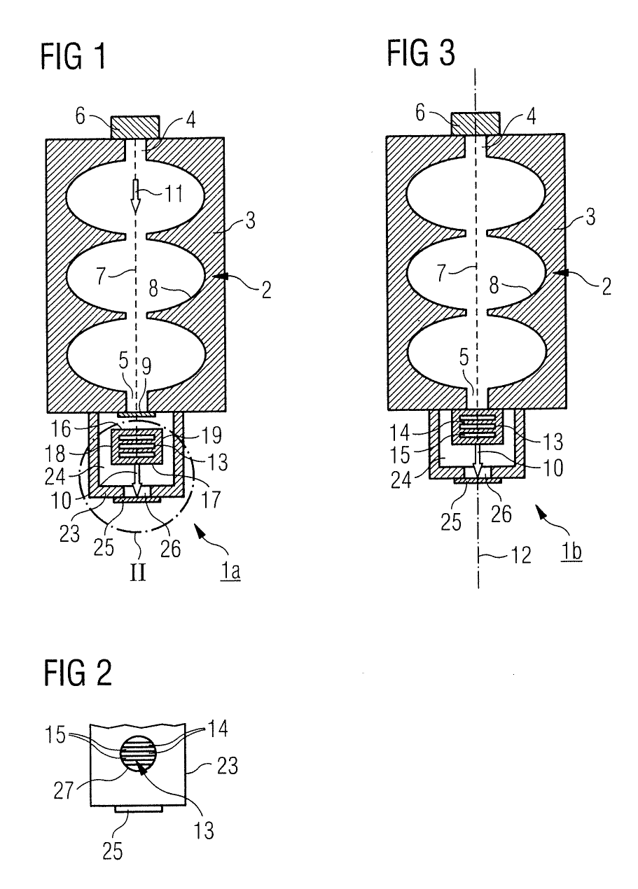

In the first embodiment variant of an electron accelerator 1a that is shown in FIGS. 1 through 3, the exit opening 5 is sealed in a vacuum-tight manner. In the case of FIG. 1, this ensues via a window 9 that is permeable to the electron beam 7, for example a window 9 consisting of titanium. A target 13 serving to convert the electron beam 7 into a Bremsstrahlung or into a photon beam 10 is positioned outside of the vacuum chamber and, due to the window 9, is not in fluid connection with the vacuum present in the vacuum chamber. The photon beam 10 emitted by the target 13 exhibits the same direction as the electron beam 7; both beams thus travel in the direction of a common beam axis 12 which penetrates the target 13. The target 13 (composed, for example, of tungsten, possibly with alloy additives) has multiple material layers 14 fashioned like lamellae. The material layers 14 are spaced (as viewed in the beam direction 11), wherein an approximately slit-shaped cooling channel 15 is formed between two adjacent material layers 14. The target 13 exhibits the shape of a cube or cuboid whose top side and underside 16, 17 are formed of a material layer 14a. Two opposite lateral surfaces 18 are closed. The cooling channels 15 lead into the remaining lateral surfaces 19.

To discharge the heat accruing in the conversion of the electron beam 7 into a photon beam 10, in operation a cooling medium (in particular deionized water) flows through the cooling channels 15. In order to ensure this it is conceivable that the lateral surfaces 19 are connected to a coolant circuit (see reference character 33 in FIG. 5). In the examples shown in FIGS. 1 through 3, the target 13 is positioned in a separate space 24 surrounded by a housing 23. A breakthrough 26 sealed with a window 25 permeable to the photon beam 10—made for example from aluminum, steel, titanium etc.—is present on a wall of the housing 23 that is situated opposite the exit opening 5 in the beam direction 11. To feed and discharge coolant, a coolant input or, respectively, coolant output respectively formed by an opening 27 is present on two diametrically opposed sides of the housing 23. The target 13 is appropriately positioned within the space 24 so that its lateral surfaces 19 direct to the lateral surfaces of the housing 23 has an opening 27. In this way the coolant flowing in through an opening 27 can arrive directly into the coolant channels 15, flow through them and—after exiting from this—leave the space 24 via the other opening 27. The heat accumulating in the transduction of the electron beam 7 into a photon beam 10 can be very effectively discharged via the described embodiment of the target or, respectively, very generally in that it said target is permeated by at least one cooling channel, such that a rotatable bearing of the target can be foregone. The kinetic energy of the photon radiation is greater than in 0.5 MeV and is in principle unlimited at the upper end.

The number of material layers 14, their thickness and the dimensions of the cooling channels 15 depend essentially on the energy of the generated photon radiation. A target 13 of, for instance, the embodiment shown in FIG. 6 is suitable to generate a photon radiation with an energy of approximately 6 MeV. Cooling channels 15 with a clearance 28 (as viewed in the beam direction 11) are present between the material layers. The ratio of the total thickness to the summed clearances of the cooling channels is 1:1. Independent of this ratio, it can be appropriate that the material layers 14 and/or the cooling channels 15 exhibit different thicknesses or, respectively, clearances 28.

The electron accelerator 16 according to FIG. 3 differs from that described above only in that the exit opening 5 is not sealed vacuum-tight by a window 9 but rather by the target 13 itself.

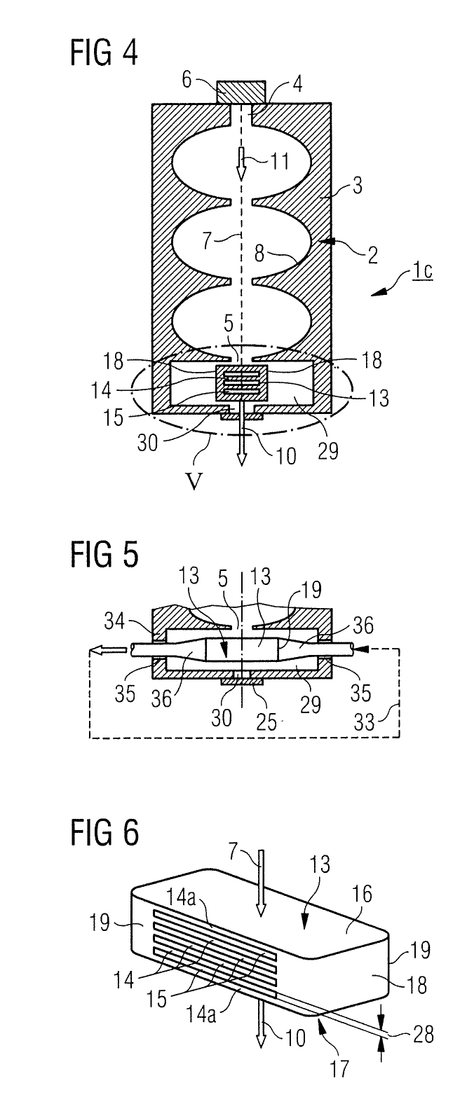

In the second embodiment variant of an electron accelerator 1c shown in FIG. 4, the target 13 is arranged in a space 29 surrounded by the housing 3 of the vacuum chamber 2. The space 29 is connected with the vacuum chamber 2 via the exit opening 5. The same vacuum as in the vacuum chamber 2 thus exists in the space 29. The space 29 does not necessarily need to be surrounded by the housing 3 of the vacuum chamber 2. Here it can also be a separate housing. In any case, a through-opening 30 is present in the wall that is sealed vacuum tight with an exit window 25 permeable to the photon beam 10. The space 29 is permeated vacuum-tight by a sub-segment of a coolant circuit 33. For this the housing wall 34 surrounding the space 29 is provided with through-openings 35 through which a tube conduit 36 is directed. The target 13 is respectively connected to the tube conduit 26 with its facing sides 19 into which the cooling channels 15 empty.

Although modifications and changes may be suggested by those skilled in the art, it is the intention of the inventors to embody within the patent warranted hereon all changes and modifications as reasonably and properly come within the scope of their contribution to the art.

We claim as our invention:

1. An electron accelerator comprising:
a vacuum chamber having an intake opening and an exit opening;
an electron source located at said input side of said vacuum chamber, said electron source emitting an electron beam;
a target located outside of said vacuum chamber next to said exit opening;
a housing outside of said vacuum chamber in which said target is contained, said housing having a window therein that is permeable to photons and located opposite said exit opening in a beam propagation direction of said electron beam;
said target being permeated by at least one cooling channel; and
said electron beam emitted by said electron source striking said target and causing generation from said target of a photon beam having an energy of more than 0.5 MeV.

2. An electron accelerator as claimed in claim 1 wherein said target has a volume region thereof permeated by said electron beam, comprising multiple material layers at respective distances from each other in said beam propagation direction, with said cooling channel being located between two adjacent layers among said multiple material layers.

3. An electron accelerator as claimed in claim 1 comprising a window closing said exit opening of said vacuum chamber, said window being sealed to said vacuum chamber with a vacuum-tight seal.

4. An electron accelerator as claimed in claim 3 wherein said exit opening of said vacuum chamber is sealed with a vacuum-tight seal by said target.

5. An electron accelerator as claimed in claim 3 wherein said target is located in a portion of said housing having a coolant input, a coolant output and said window that is permeable to photons.

6. An electron accelerator as claimed in claim 5 wherein said cooling channel proceeds between two opposite sides of said target, said opposite sides respectively facing said coolant input and said coolant output.

7. An electron accelerator as claimed in claim 1 wherein said target is located in a space connected to said vacuum chamber via said exit opening, said space encompassing said window that is permeable to photons.

8. An electron accelerator as claimed in claim 7 wherein said space is permeated by a coolant circuit in a vacuum-tight manner, said cooling channel that permeates said target being connected to said coolant circuit.
